(19) United States
(12) Patent Application Publication
(10) Pub. No.: US 2004/0035124 A1
(43) Pub. Date: Feb. 26, 2004

(54) Portable battery powered freezer monitor

(76) Inventors: Jack Nicklas Lucas, Taylorsville, UT (US); Fredric Joseph Lucas, South Jordan, UT (US)

Correspondence Address: STEVEN L. NICHOLS, RADER, FISHMAN & GRAVER PLLC, 10653 S. RIVER FRONT PARKWAY, SUITE 150, SOUTH JORDAN, UT, 84095, US

(21) Appl. No.: 10/646,418

(22) Filed: Aug. 22, 2003

Related U.S. Application Data
(60) Provisional application No. 60/405,439, filed on Aug. 22, 2002.

(51) Int. Cl. F25B 49/00; G01K 13/00

(52) U.S. Cl. 62/130; 62/126

(57) ABSTRACT

A cold storage monitor or indicating audibly, visually, or both; when a predetermined temperature in the cold storage apparatus is reached. The monitor may include a power supply, a temperature gauge, an audible alarm coupled to the power supply, a visual alarm coupled to the power supply, where the audible and visual alarms activate when the temperature gauge measures the predetermined temperature.

### FIELD OF THE INVENTION

The present invention relates to cold storage monitoring, more specifically, the present invention relates to a portable battery powered freezer monitor.

### BACKGROUND OF THE INVENTION

Refrigeration and freezer units provide temperature controlled environments that facilitate preservation of food or other temperature sensitive items. These units are typically sealed from the external environment in order to maximize their efficiency. In addition, many of these units are substantially self regulated in that they maintain the internal temperature within a specified range through the use of temperature controllers or other systems. However, on occasion the temperature within the unit may deviate from the specified temperature range. This deviation may be due to such events as power outages, temperature control malfunction, or other malfunctions within the refrigeration unit. Such events can cause the spoilage or ruin of food or other items within the unit. These events often go undetected due to the sealed nature of typical refrigeration or freezer units.

Recent systems have attempted to solve this problem by providing a sensor within the unit for monitoring the temperature and a system of alarms and controls external to the unit. Such systems are typically inconvenient in that they require external power sources and complicated monitoring systems.

### SUMMARY OF THE INVENTION

In one of many possible embodiment, the present invention provides a cold storage monitor comprising: a power supply; a temperature gauge; an audible alarm coupled to the power supply; a visual alarm coupled to the power supply; wherein the audible and visual alarms activate when the temperature gauge measures a predetermined temperature.

In some embodiments the power supply is a battery. The battery may be coupled to a battery power indicator.

In some embodiments the present invention provides a freezer monitor comprising: a battery; a thermocouple; an alarm; circuitry programmed to monitor a temperature measured by the thermocouple and activate the alarm when the temperature reaches a predetermined threshold; and a batter power indicator. The monitor may also include a thermistor.

There is also provided a method of preventing food thawing comprising: inserting a thermocouple into a cold storage device; monitoring a temperature in the cold storage device with the thermocouple; setting off an alarm when the temperature reaches a predetermined threshold. According to the method there may also include monitoring a power supply coupled to the thermocouple and visually indicating a power level of the power supply.

### BRIEF DESCRIPTION OF THE DRAWINGS

The accompanying drawings illustrate various embodiments of the present invention and are a part of the specification. Together with the following description, the drawings demonstrate and explain the principles of the present invention. The illustrated embodiments are examples of the present invention and do not limit the scope of the invention.

FIG. 1 is a perspective assembly view of a portable freezer monitoring apparatus according to one exemplary embodiment.

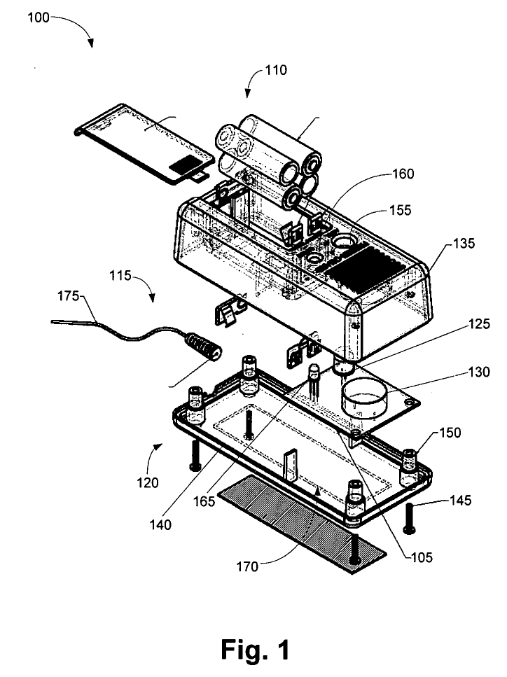

Throughout the drawings, identical reference numbers designate similar, but not necessarily identical, elements.

### DETAILED DESCRIPTION OF THE PREFERRED EMBODIMENTS

A monitoring apparatus such as a freezer guard (100) may be a solid-state battery operated temperature monitoring and notification/alarm device. The freezer guard may be useful in both residential or commercial freezers and other cold storage devices. Continuously monitoring temperature within the freezer compartment by the freezer guard will create an alarm if the temperature within the compartment rises above a predetermined temperature, for example 30 degrees F. If an alarm condition exists, an audible and/or visual notification may be presented. The alarm is intended to warn an operator of a possible trouble condition within the freezer operation and that temperature within the freezer may reach or have reached an undesirable temperature.

The freezer guard (100) generally includes an alarm system (105), a power supply assembly (110), a monitoring system (115) and a housing assembly (120).

A visual alarm produced by the alarm system (105) is exhibited through the use of an alarm LED (125) or other indicator mounted in the housing assembly (120). The alarm LED (125) pulses a light such as a bright red light at an interval, for example 5-second intervals, when an alarm condition exists.

An audible alarm produced by the alarm system (105) is exhibited by audible alarm (130), also mounted within housing, which provides an intermittent or continuous sound, such as a whistle, when in the alarm condition.

As discussed, the alarm system is located within the housing assembly (120). The housing assembly (120) includes a front housing (135) and a back housing (140) that are coupled by screws (145) that extend through pins (150) in the back housing (140) into the front housing (135). The visual alarm is seen through a visible alarm opening (155) defined in the front housing (135). A status indicated opening (160) is also defined in the front housing (135).

The freezer guard may include a battery status LED indicator (165) that is coupled to the power supply assembly (110). This indicator provides information as to the available battery voltage or power. When voltage or power is sufficient to operate the freezer guard (100) properly the battery status LED indicator (165) glows a first color such as green. When the voltage is insufficient to operate the freezer guard (100) properly battery status LED indicator (165) glows a second color such as red. Voltage is supplied by batteries (170).

The freezer guard's monitoring system (115) may incorporate a thermistor with a 24″ capillary (175) according to one embodiment. This capillary (175) is inserted between the door of the freezer (not shown) and the weather stripping of the freezer (not shown) into the freezer compartment (not shown). When inserted into the freezer compartment, the thermistor signal is monitored for temperatures regularly, for example every 10 seconds, by the solid-state circuitry (not shown).

The freezer guard (100) is easy to install on most any cold storage device (freezer, refrigerator, etc) by simply attaching a connector such as a 1″×3″ piece of double sided tape to the recessed area (180) defined in the back housing (140) and attaching the freezer guard (100) to the exterior of the freezer. The freezer guard (100) may be placed close enough to the opening of the freezer or other cold storage device to allow for a minimum of about 3 to 20 inches, preferably about 8 inches, of insertion length of the capillary (175) into the freezer compartment.

The freezer guard is a substantially portable unit, utilizing a self-contained power source and a monitoring system requiring a minimum of external hardware. This configuration facilitates ease of installation and use while providing a cost-efficient system for use in both home and industry.

The preferred embodiment was chosen and described in order to best illustrate the principles of the invention and its practical application. The preceding description is intended to enable others skilled in the art to best utilize the invention in various embodiments and with various modifications as are suited to the particular use contemplated. It is intended that the scope of the invention be defined by the following claims.

### RELATED APPLICATIONS

The present application claims priority under 35 U.S.C. § 119(e) from the following previously-filed Provisional Patent Applications, U.S. Application No. 60/405,439, filed November 27, 2001 by Jack Lucas et al., entitled “Portable Battery Powered Freezer Monitor” and which is incorporated herein by reference in its entirety.-Attorney

What is claimed is:

1. A cold storage monitor comprising:
a power supply;
a temperature gauge;
an audible alarm coupled to said power supply;
a visual alarm coupled to said power supply;
wherein said audible and visual alarms activate when said temperature gauge measures a predetermined temperature.

2. The monitor of claim 1, wherein the power supply is a battery.

3. The monitor of claim 2, further comprising a battery power indicator.

4. A freezer monitor comprising:
a battery;
a thermocouple;
an alarm;
circuitry programmed to monitor a temperature measured by the thermocouple and activate the alarm when the temperature reaches a predetermined threshold; and
a battery power indicator.

5. The monitor of claim 4, further comprising a thermistor.

6. A method of preventing food thawing comprising:
inserting a thermocouple into a cold storage device;
monitoring a temperature in the cold storage device with the thermocouple;
setting off an alarm when the temperature reaches a predetermined threshold.

7. The method of claim 6, further comprising monitoring a power supply coupled to the thermocouple and visually indicating a power level of the power supply.
